(19) United States
(12) Patent Application Publication
(10) Pub. No.: US 2009/0070167 A1
(43) Pub. Date: Mar. 12, 2009

(54) Rule based product assessment method and apparatus

(76) Inventors: John Benad, Postdam (DE); Thoralf Nehls, Jesteburg (DE); Alexander Redlich, Potsdam (DE); Heiko Rentsch, Dresden (DE)

Correspondence Address: NIXON PEABODY, LLP, 401 9TH STREET, NW, SUITE 900, WASHINGTON, DC, 20004-2128, US

(21) Appl. No.: 11/898,482

(22) Filed: Sep. 12, 2007

(51) Int. Cl. G06Q 10/00

(52) U.S. Cl. 705/7

(57) ABSTRACT

A computer implemented method, and apparatus, and a computer readable media for automated processing of standard cost estimates for business activities. A standard cost estimate indicating standard costs of a business activity is defined. A design pattern is used to encapsulate product characteristics including, defining at least one change request based on a production scenario, and modifying the standardized cost estimate. An updated standardized cost estimate indicating updated cost of the business activity based on the at least one change request is then derived.

### BACKGROUND OF THE INVENTION

1. Field of the Invention

The invention generally relates to the field of enterprise resource planning, particularly to the assessment of cost of goods manufactured, and, more specifically to a technique of deriving cost estimates for given scenarios based on standard cost estimates.

2. Description of the Related Art

Enterprise resource planning systems are used for unified integration of all data and processes of an organization. Typically, an enterprise resource planning system uses multiple components of computer software and hardware to achieve the integration. One important software module is a unified database to store data for the various system modules. Depending on the size of the systems, data modules and system modules may be both physically and logically distributed. Physical distribution means that the components are spread over different hardware (e.g. servers) whereas logical distribution describes a functional separation of software modules which may be implemented on the same hardware platform. The term “modules”, as referred to herein, means software capable of running on a hardware platform. Modules are define by function and need not be a single file set at code or running on single hardware platform. For example, a module can be a single executable file, multiple executable files or portion of a single or multiple executable files. All of the functions described herein can be implemented as modules.

Enterprise resource planning systems used to be implanted only in the manufacturing environment, but today they are used in a much broader scope, i.e. covering all basic functions of an organization, regardless of the organization's business character. Generally, the benefit of an enterprise resource planning system is to replace two or more independent applications eliminating the need for external interfaces previously required between systems, and providing additional benefits ranging from standardization and lower maintenance (one system instead of two or more) to easier and/or greater reporting capabilities as all data is typically kept in one database with only one well defined interface.

The term “costing” describes the process of identifying the costs of the business and of breaking them down and relating them to the various activities of the organization. In order to determine the factory costs for a given product, typically cost estimates are developed at all stages of a product development and product production cycle based on a plurality of scenarios describing characteristics such as potential future variations of schedule, production site, technology, suppliers, subcontractors, tariffs, prices etc. In other words, costing is a process which requires analysis, simulation, and optimization of future production cost.

The analysis phase covers identifying characteristics such as all raw materials, preliminary products and production passes necessary to manufacture the final of finished product. In the simulation phase the influence of technical alternatives, increasing product and project complexity and innovation management is examined including the evaluation of economic alternatives such as the trade-off between make or buy, the production site selection, the supplier selection and the target date for the start of the production.

Finally, in the optimization phase the processing of data obtained in the simulation phase is structured in a beneficial manner, usually to minimize the overall cost.

Though these steps could be performed by spreadsheet calculation (or in simple cases even manually) it is evident that in order to increase efficiency, the costing of complex products require structuring, standardization, versioning, automated quality testing, audit proof archiving and incorporation of different calculations.

The costing process is subjected to market trends such as cost pressure and risk dislocation requiring a design to cost or target cost calculation or defined usage of standardized parts.

If a high proliferation of options is important, costing includes variant management for simulation of technical alternatives such as product structures, production and processes. If, however, an increased outsourcing is desired, variant management for simulating economical alternatives with respect to the selection of suppliers and determination of the right place and time is required.

Product globalization has to be budgeted by a cost, process analysis, product- and project controlling and a deliberate investment management. Finally, increased differentiation requires innovation management and a benchmark with function costs analysis. In Summary, costing captures various trends by means of methodical expertise resulting in a combination of technical and economical perspectives by identification of the specific cost drivers, the defined usage of standardized parts and a lifetime simulation.

As a module of the enterprise resource planning system, this costing module is often highly communicative with other modules and the user of the system to provide cost transparency for a flexible reporting system. For example if a customer requests a quotation for a certain product from a supplier expecting a pricing of the quotation based on the requirements stated either in the quotation or by reference to known industry standards, the costing module must collect various data. The supplier starts with a decision whether or not the product meets the given requirements. If this decision is positive, the supplier either imports an existing calculation of a bill of materials or creates a new product structure. Now the supplier initiates and internal optimization process by iteratively adapting the calculate towards the cost target. This phase includes the identification of cost reduction potential, costed evaluation of technical alternatives, suppliers and site selection. Ideally, the supplier meets the cost target and starts the production after signing the contract with the customer. One should note that depending on the type of industry, the unilateral calculation towards the cost target could also include the cost consideration of the entire value chain, integrating suppliers and customers, e.g. by aiming at stronger negotiation positions when purchasing raw materials or by balancing product cost versus cost in use.

While optimizing the cost relevant parameters in order to meet the cost target, a multitude of possible production scenarios should be considered: A simulation might for instance suggest to postpone the start of production (e.g. when a drastic decrease in purchase price for product parts is to be expected in the future). Usually, production costs can vary considerably among different production sites, the simulation should be able to calculate these differences and utilize them for the compilation of best and worst case scenarios. The same holds for the evaluation of alternatives in production technology.

The cost of a product crucially depends on the choice of suppliers for purchased parts and the availability of block pricing and rebates. The simulation should be able to weigh all these factors against each other automatically and suggest an optimal set of choices between alternatives. It is usually important that the various scenarios to be analyzed are managed separately from a standard cost estimate, i.e. it is desirable that the scenarios can be embodied in derived cost estimates.

Traditional costing approaches require a full cost estimate which has to be recursively calculated on a nested product structure for each scenario separately, resulting in a high computational complexity if a large number of scenarios are simulated on complicated products. This is especially the case if the required products are not based on raw material but also require a design and manufacturing cycle. The complex dependencies of a citing process cannot be easily tracked by means of static lists or simple spread-sheet calculation.

### SUMMARY OF THE INVENTION

A first embodiment of the invention is a computer implemented method for automated processing of standard cost estimates comprising defining and storing a standard cost estimate indicating standard costs of a business activity, using a design pattern to encapsulate product characteristics, and deriving an updated standardized cost estimate indicating updated cost of the business activity based on the at least one change request.

A second embodiment of the invention is a computer readable medium comprising instructions for defining and storing a standard cost estimate indicating standard costs of a business activity, using a design pattern to encapsulate product characteristics, and deriving an updated standardized cost estimate indicating updated cost of the business activity based on the at least one change request.

A third embodiment of the invention is a system for automated processing of standard cost estimates comprising a device for defining and storing a standard cost estimate indicating standard costs of a business activity, a device for using a design pattern to encapsulate product characteristics, and a device for deriving an updated standardized cost estimate indicating updated cost of the business activity based on the at least one change request.

### BRIEF DESCRIPTION OF THE DRAWING

Reference will now be made in detail to the present preferred embodiments of the present invention, examples of which are illustrated in the attached drawing, wherein like reference numerals refer to like elements throughout.

FIG. 1 is a flow chart representing an exemplary embodiment of the invention.

FIG. 2A illustrates an interface between an user, a computer and a persistent storage.

FIG. 2B illustrates an interaction between an user, a graphical user interface (GUI) and a sequence of operation triggered by an user.

FIG. 3 illustrates the command pattern approach as known from prior art.

FIG. 4 illustrates the command pattern as approach adapted on a basis of the present invention.

FIG. 5 illustrates the base calculation FIG. 1 in more detail.

FIG. 6 illustrates the change description FIG. 1 in more detail.

FIG. 7 illustrates the modification of the standardized cost estimate (step 105 of FIG. 1) in more detail.

FIG. 8 illustrates the derived calculation (step 106 of FIG. 1) in more detail.

### DETAILED DESCRIPTION

Embodiments of the present invention by provide an interface to an enterprise resource planning system in order to simplify analysis, simulation and optimization of the costing process of a product. In one example, a computer implemented method for automated processing of standard cost estimates comprises defining and storing a standard cost estimate, using a design pattern to encapsulate product characteristics for defining one or many change requests, modifying the standardized cost estimate and deriving an updated standardized cost estimate based on the change requests.

An important distinction can be made between manual updates of standard cost estimates based on reliable data on the one hand, and the formulation of change requests to these estimates depending on possible production scenarios and based on assumptions of varying reliability on the other hand. The following procedure has been devised in order to keep track of the manual updates as well as the management of change requests. The method enables repeated, automatic, and selective application of change requests to an evolving standard cost estimate.

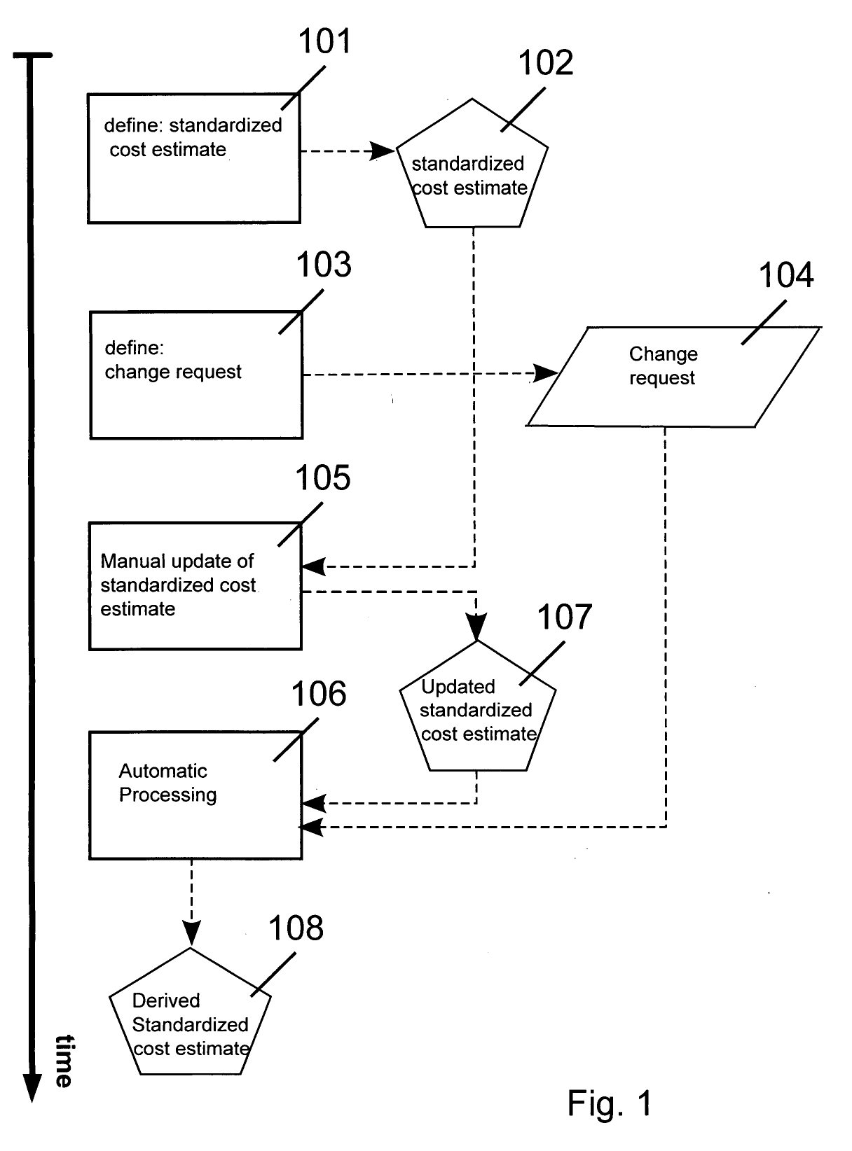

As illustrated in FIG. 1, the initial standard cost estimate 101 is defined which will be denoted as standard cost estimate 102 and can be retrieved later for manual update step 105 which results in an updated standardized cost estimate 107. Independently of the update of standard cost estimate 102, a single or multiple change requests can be formulated in step 103 and saved as change request 104 for later automatic processing step 106 resulting in a derived standardized cost estimate 108.

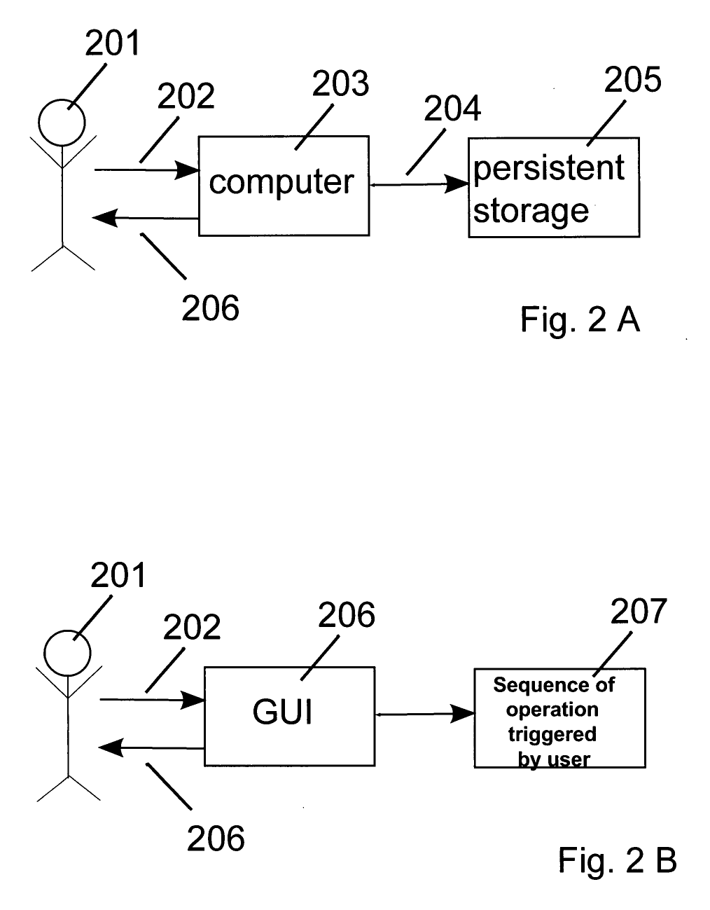

FIG. 2A illustrates the interaction of the user 201 with the computer system 203 by using a graphical user interface or a data import from other modules of the enterprise resource planning system to enter data 202. Computer System 203 starts processing the data according the flow diagram illustrated in FIG. 1. Persistent storage 205 refines input data, specifically a standardized cost estimate and parameters needed by the automatic processing step 106. Further, the computer system 203 presents the user 201 with a derived cost estimate by means of a graphical user interface or data export function. Data import and data export may be implemented by means of an inter-module Application Program Interface (API) or the file or network socket based exchange of plain text or structured data, such as the Extensible Markup Language (XML).

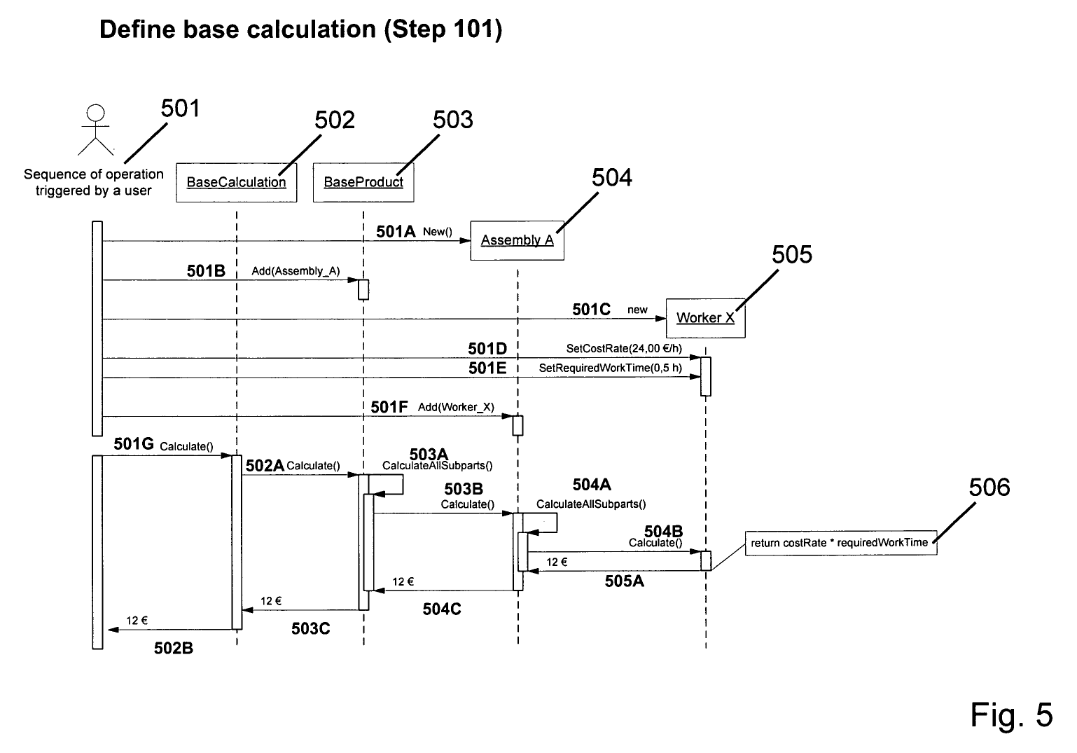

FIG. 2B illustrates the user 201 interacting with graphical user interface 206 of computer system 203 resulting in a sequence of operations 207 triggered by the user and illustrated in greater detail in FIGS. 5-8.

Costing is a recurring operation of enterprise resource planning which is an attempt to integrate all data and processes of an organization into a unified system. Typically an enterprise resource planning system consists of multiple components of computer software and hardware to achieve the integration. In an industrial environment the cost for a finished product is usually determined by the sum of the raw materials needed for manufacturing this particular product plus a number of additional dependent cost factors such human resources and tools needed for the manufacturing process. Naturally an enterprise seeks close to optimal operation conditions, namely full load of the machinery, modest workload of employees and maximization of the raw materials.

Typically process optimization can be archived by iterative updates of table-like data, with the aid of spread sheet calculation such as Microsoft EXCEL, for example. Spread sheet calculation programs allows implement action of dependencies by means of programming—either graphical user interface based, or command driven—as long the items of interest can be represented by numbers, or a limited vocabulary and simple conditional dependencies known from basic programming language, such as IF-THEN-ELSE statements. On the other hand, object oriented programming languages such as C#, JAVA, C++ or PHP allow more sophisticated implementation of rules and dependencies—at the expense of higher complexity and the need for adaptation to the specific optimization goal.

The preferred embodiment of the present invention makes use of design patterns known from software engineering generally describing a repeatable solution to a commonly occurring problem in software design. Object-oriented design patterns typically show relationships and interactions between classes or objects, without specifying the final application classes or objects that are involved. Computer science differentiates between fundamental patterns, creational patterns, structural patterns, concurrency patterns and behavioral patterns. The latter are used to identify common communication patterns between objects. Several implementations are known from literature. Interpreter patterns implement a specialized computer language in order to solve a specific set of problems. Specification patterns are used to implement recombinable business logic in a Boolean fashion whereas strategy patterns allow selection of algorithms on the fly. Especially in message driven systems like operating systems, Observer patterns are used for publishing or subscribing to event listeners where objects register to observe an event which may be raised by another object.

Yet another design pattern is the command pattern which allows encapsulation of a request as an object, thereby letting a user parameterize clients with different requests, queue or log requests, and support external operations. In other words, command pattern implements commands as objects and are typically used for implementing transactional behavior, thread pools or macro recording. It is also possible to send serialized command objects across the network to be executed on other computers.

More precisely, instead of processing a command as simple text a command class is generated which actually contains the actual command as a parameter. This approach is advantageous because the object can inherit properties from other objects. One of the standard properties of objects generated using object oriented programming language is serialization which allows storing an object as binary data to a data storage or transmitting the data across a network.

These properties are leveraged in the preferred embodiment to achieve novel and unexpected results. used by the present application in a beneficial way: Command objects may store complex rules which can be applied by simple execution of the object carrying these rules simplifying the analysis of complex scenarios. Common behaviors are identified and packaged in reusable libraries and frameworks. In particular, large applications benefit by avoiding duplicate code which is difficult to maintain.

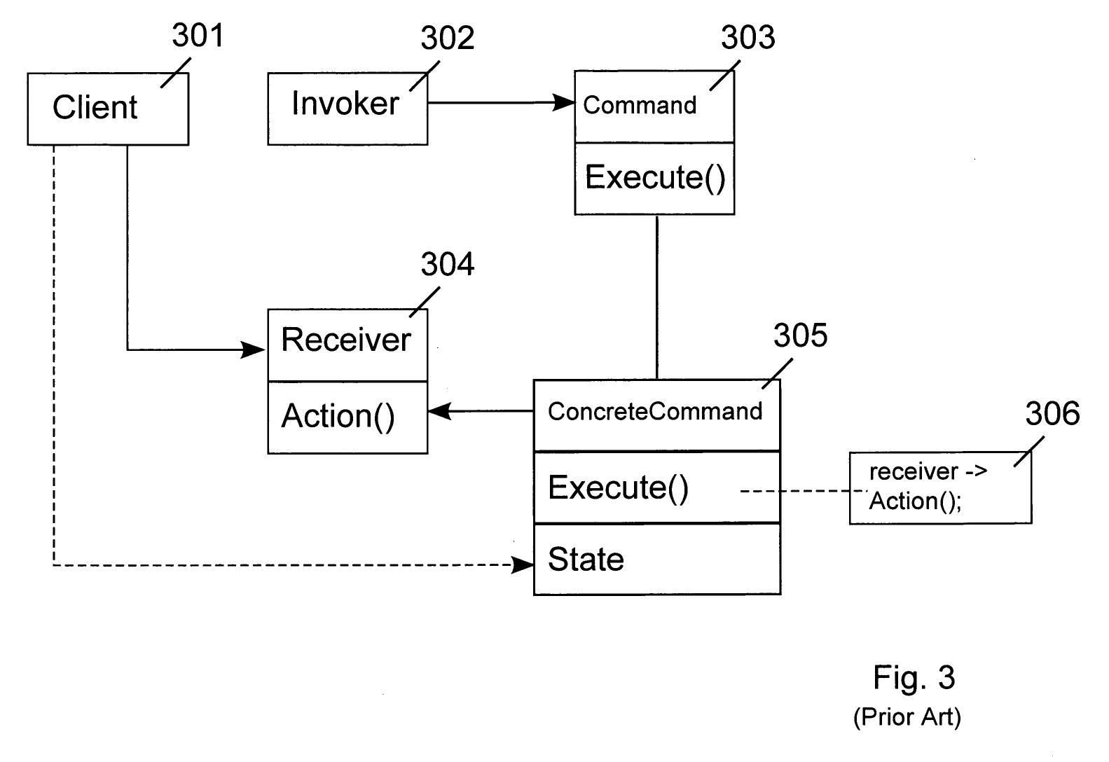

FIG. 3 is a flow chart of the command pattern approach originally from “Erich Gamma, Richard Helm, Ralph Johnson and John Vlissides Design Patterns Elements of Reusable Object-Oriented Software”, Addison Wesley, 1995. A client application 301 initiates a command by creating a ConcreteCommand object 305 and setting its receiver 304. The ConcreteCommand object defines a binding between a Receiver object 304 and an action 306. It also implements the Execute Operation 305 by invoking the corresponding operation(s) on the Receiver 304. The command 303 declares an interface for executing an operation. The Invoker 302 asks the command 303 to carry out the request. Finally, the Receiver 304 knows how to perform the operations associated with carrying out a request.

From a developers perspective, command patterns effectively separate the execution of a command 303, i.e. an abstract base class for all command objects from its invoker 302. The invoker itself does not need to know anything about the command at all except that it is required to implement the Execute method. Any concrete command 305 which is any number of classes derived from the command class 303 can be implemented as a single object with an Execute method that implements its behavior.

In one embodiment of the present invention the Microsoft NET framework is used to implement the command pattern adapted to the problem of costing. So the invoker may be implemented either as a Windows Service Application or as stand-alone application. Service applications have the advantage of automatic startup at boot time of the operating system. An invoker service can be stopped while commands build up in the queue. Once the service is restarted is continues with the next command in a queue.

In order to accomplish scalability in complex systems, a distributed command architecture using a dispatcher concept may be used: The dispatcher serves as virtual service endpoint, optionally with a load-balanced queue behind it. Note that the dispatcher might be implemented to accept commands from remote systems by means of remote procedure calls. A remote procedure call is a popular model for implementing distributed client-server computing environments. As suggested by its name, this approach to concurrency works as follows: A process requests another process to do work by executing a remote procedure call, using a well-defined interface for the service to be performed. The processor executing the remote procedure call starts a process to service the request, which performs the desired work, returns the result, and finally terminates.

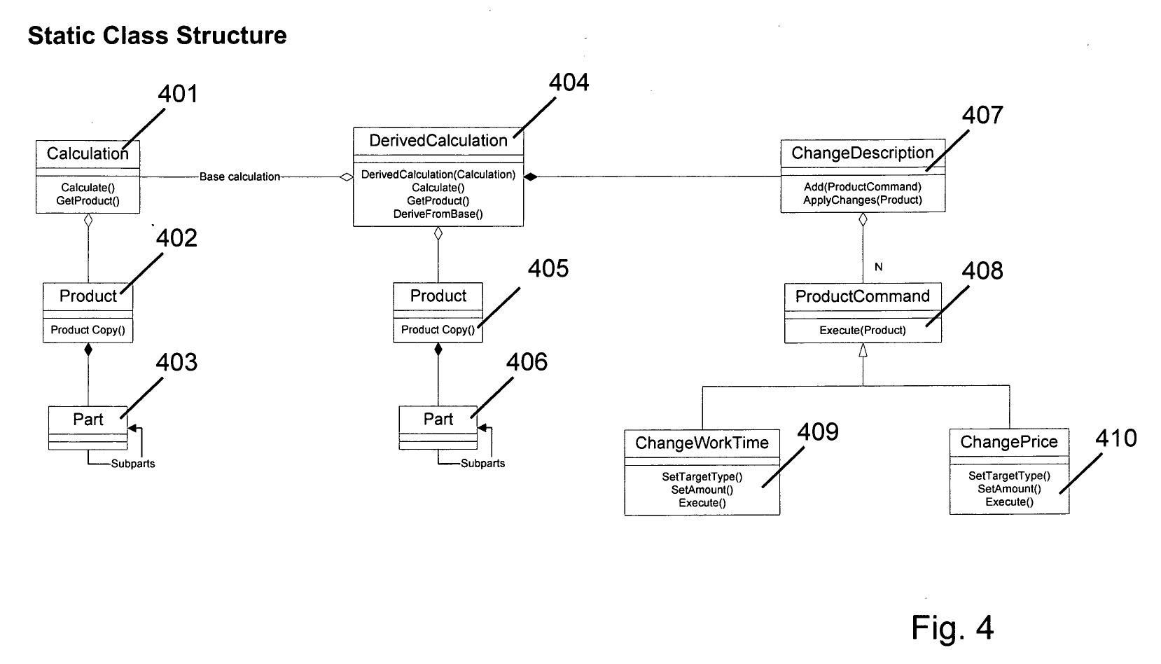

FIG. 4 illustrates the adaptation of the Command Pattern approach towards the costing of a product. A calculation class 401 provides two methods Calculate( ) and GetProduct( ). The calculation class holds the information of a product to be calculated by means of a reference to a class Product 402 (implementing a method Product copy( ). Objects of the Product class are composed of a nested structure of objects of class Part 403 (Parts can have sub-parts via the relation Subpart). Another class DerivedCalculation 404 (which holds a reference to the class Calculation representing its base calculation) provides the methods DerivedCalculation( ), Calculate( ), GetProduct( ) and DeriveFromBase( ). Product 405 and Part 406 class correspond to 402 and 403 respectively.

Yet another class ChangeDescription 407 implements AddProductCommand( ) and ApplyChanges( ), and can contain a multitude of objects of classes ProductCommand 408. By means of inheritance, the classes ChangeWorkTime 409 and ChangePrice 410 are defined as (exemplary) specialized ProductCommands which can be utilized by class ChangeDescription to describe the changes of the calculation parameters work time or price, respectively.

FIG. 5 illustrates further details on step 101 of FIG. 1 according to one embodiment of the present invention: In a sequence of operation 501 triggered by the user, the following actions are taken: A new objected called Assembly A 504 is created 501A which is then Added 501B to the BaseProduct 503 object. After that, a new WorkerXobject 501C is created implementing methods SetCostRate 501D and SetRequired Work 501E which are also invoked by the sequence of operation triggered by the user, and by means of which the user specifies the cost of labor per hour as well as the amount of time required by worker X for mounting Assembly A Such configured WorkerX object is then Added 501F to the Assembly A 504

Upon invocation of the Calculate method 501G of the BaseCalculation 502 class, a CalculateAllSubparts( ) 503A method is executed resulting in a Calcutate( ) 504B action of the Worker X class In step 506 the actual cost is derived by multiplying cost rate by the required work time set in step 501D and 501E respectively.

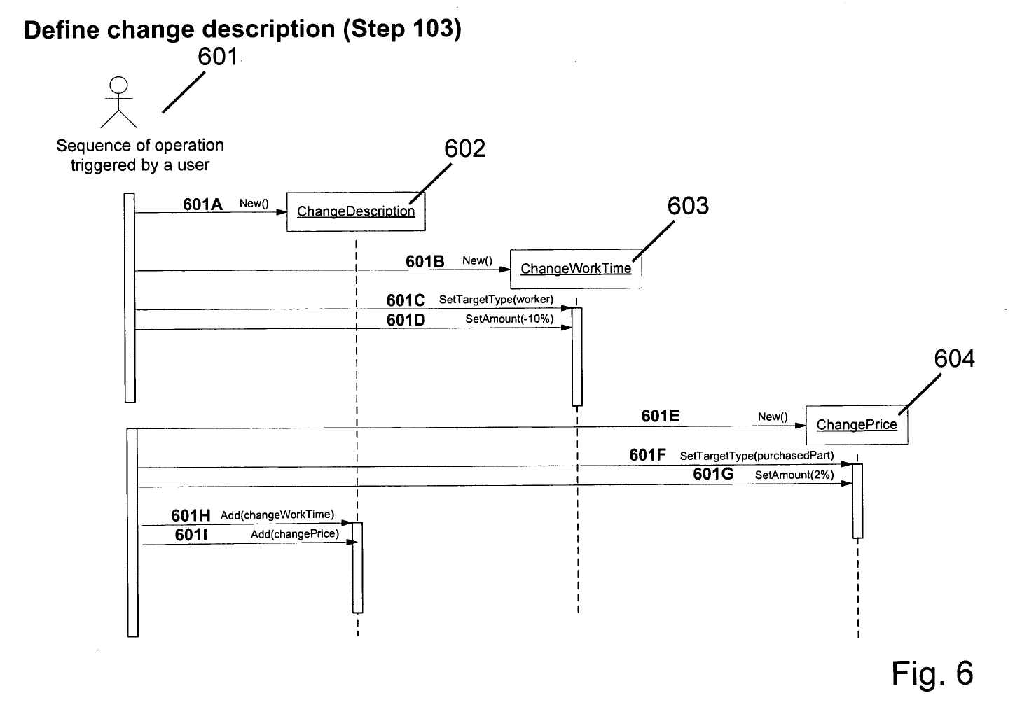

FIG. 6 illustrates the change description (step 103 of FIG. 1) according to one embodiment of the present invention in more detail. In a sequence of operation triggered by a user a new instantiation of the ChangeDesription 602 Object is created. Also, a new instantiation of object Change WorkTime 603 is created implementing SetTargetType( ) and SetAmount( ) methods which is invoked in steps 601C and 601D respectively. Similar, a new instantiation of object ChangePrice 604 is created which implements two methods SetTargetType( ) and SetAmount( ) which are invoked in steps 601F and 601G. Finally, the changeWorkTime object 601H and the changePrice 6011 object is added to the ChangeDescription 602.

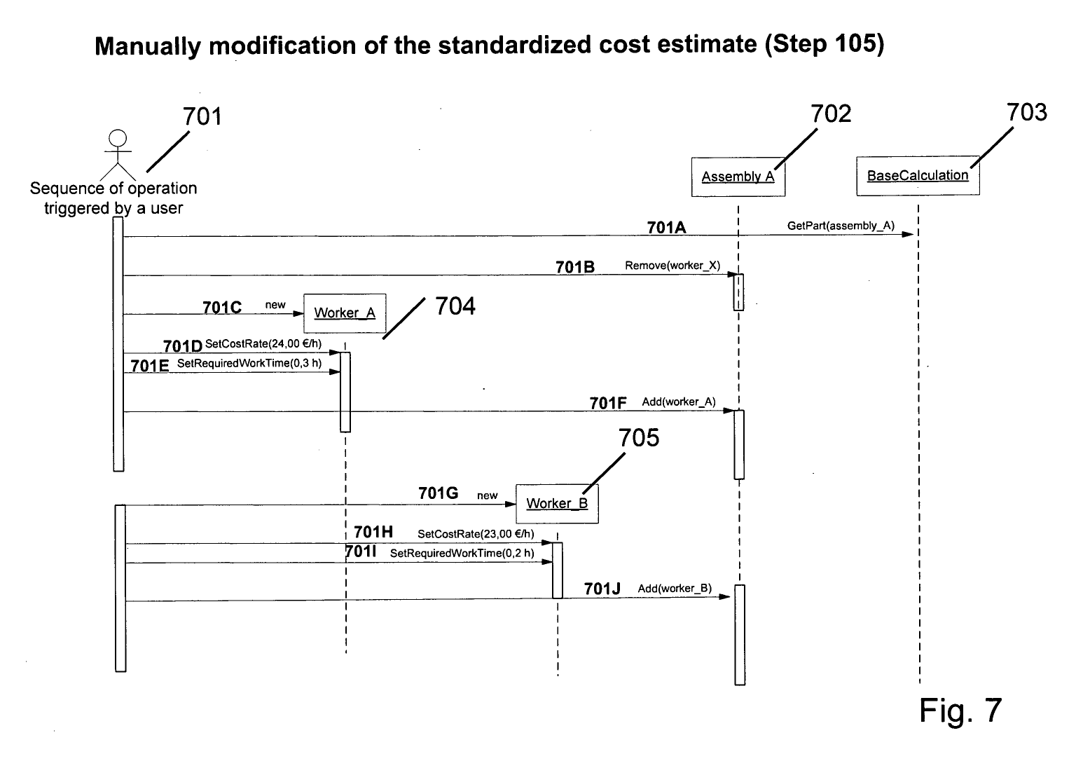

FIG. 7 illustrates the modification of the standardized cost estimate (step 105 of FIG. 1) according to one embodiment of the present invention in more detail. In a sequence of operation triggered by a user the GetPart method 701A of class BaseCalculation 703 is called with Assembly_A as parameter. Next, the Remove(worker_X) of class Assembly_A 702 is called. Then a new Worker_A 704 object is instantiated. User triggered input SetCostRate( ) 701D and SetRequiredWorkTime( ) 701E is attached to said object followed by an Add(worker_A) method call 701F of Assembly_A. A second object Worker_B 705 is created and parameterized, too. (steps 701H and 701I, SetCostRate( ) and SetRequiredTime( ). Finally, Worker_B is added to Assembly_A 702 as well.

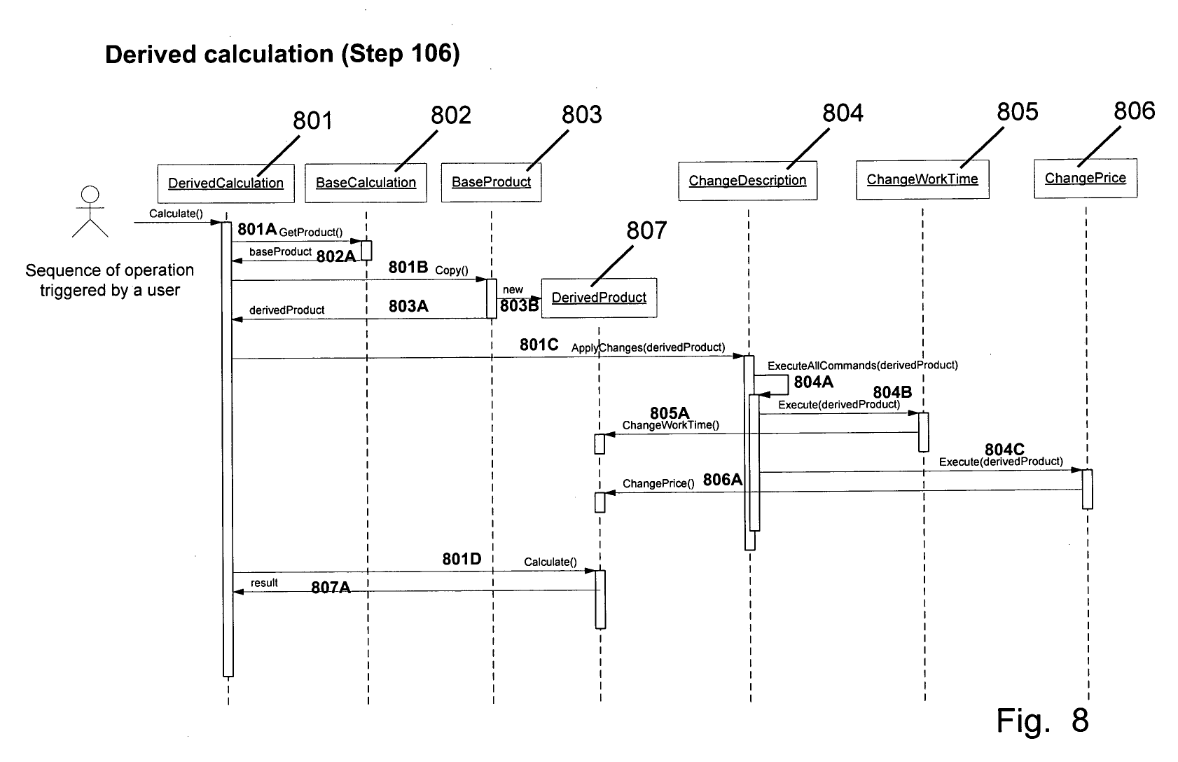

FIG. 8 illustrates the derived calculation (step 106 of FIG. 1) according to one embodiment of the present invention in more detail. The sequence of operation triggered by a user results in a call of the Calculate( ) method of class DerivedCalculation 801. A GetProduct( ) request 801A is fulfilled by object BaseCalculation 802 by returning the baseProduct description to DerivedCalculation 801 which is directly copied via a call to BaseProduct. Copy( ) 803 resulting in the instantiation of a new DerivedProduct 807 which is returned to DerivedCalculation 801. Upon calling the ApplyChanges method 801C, the ChangeDescription 804 class issues an ExecuteAllCommands 804A call triggering ChangeWorkTime 805 and ChangePrice 806. Finally the calculates method 801D is called and the result of the calculation 807A is returned and can be interpreted by the user.

In summary, a product (a detailed description of the production of a concrete product) implements an interface that allows for modification of cost relevant parameters like WorkTime and Price. The ChangeDescription employs command objects like ChangeWorkTime and ChangePrice for storing changes on those parameters for products in general.

The DerivedCalculation object triggers the execution of the commands stored in a ChangeDescription on a concrete Product. The result is a DerivedProduct which can be calculated by the DerivedCalculation automatically using the changed parameters.
The whole process runs automatically, the user only initiates it by requesting a derived calculation of a product.

Applying this to a risk analysis scenario, the user would define the costing adopting basic conditions which will be stored as standardized cost estimate. In order to obtain costing for the best and worst case scenario in a conventional approach the user would have to compile several different calculations, since it might not be obvious which combination of cost relevant parameters is optimal. For instance, Supplier A may be cheaper for part X and more expensive for part Y compared to Supplier B, but for reasons of rebates and block prices it might be necessary to choose either A or B for both X and Y. Now this choice depends on how many X-parts and Y-parts are needed, which might in turn depend on technology issues and be a cost relevant parameter as well. In short, cost relevant parameters might interact, and it is useful to be able to handle (many) derived calculations automatically.

The method disclosed by this application would automatically process best and worst case costing based on Rules and properties of each product involved in the production process. Related to the given example, this would include rules for price changes, such as general advances in prices, as well as position changes, such as discontinuation of positions or adding new positions. It allows one to create many different derived calculations by means of combination of different change descriptions.

The functions described herein can be accomplished by any computer or computer system programmed in a known manner. The various modules can be executed on a single computer or processor or distributed over various computers or processors.

Although the present invention has been described herein in considerable detail with reference to particular exemplary embodiments, certain modifications or alterations may be apparent to those skilled in the art, without departing from the scope of the invention. The exemplary embodiments are meant to be illustrative, not limiting the scope of the invention, which is defined the following claims.

1. A computer implemented method for automated processing of standard cost estimates comprising:
defining and storing a standard cost estimate indicating standard costs of a business activity;
using a design pattern to encapsulate product characteristics comprising
defining at least one change request based on a production scenario;
modifying the standardized cost estimate; and
deriving an updated standardized cost estimate indicating updated cost of the business activity based on the at least one change request.

2. The method of claim 1, wherein the encapsulated product characteristics are formulated as rules describing the dependency between the product characteristics.

3. The method of claim 1, wherein a manual change of the standard cost estimate does not affect the possibility for an automated processing.

4. The method of claim 1, wherein the original standard cost estimate is stored in a persistent data storage device.

5. The method of claim 1, wherein the design pattern is a command pattern.

6. The method of claim 2, in herein the rules comprise rules for price changes and position changes.

7. A computer readable medium having a program of instructions executable by a computer to perform a method for automated processing of standard cost estimates, the instructions comprising:
instructions for defining and storing a standard cost estimate indicating standard cost of a business activity;
instructions for using a design pattern to encapsulate product characteristics comprising
instructions or defining at least one change request based on a productions scenario;
instructions for modifying the standardized cost estimate; and
instructions for deriving an updated standardized cost estimate indicating updated costs of the business activity based on the at least one change request.

8. The medium of claim 7, wherein the encapsulated product characteristics are formulated as rules describing the dependency between the product characteristics.

9. The medium of claim 7, wherein a manual change of the standard cost estimate does not affect the possibility for an automated processing.

10. The medium of claim 7, wherein the original standard cost estimate is stored in a persistent data storage device.

11. The medium of claim 7, where the design pattern is a command pattern.

12. The medium of claim 4, wherein the rules comprise rules for price changes and position changes.

13. A system for automated processing of standard cost estimates, comprising
means for defining and storing a standard cost estimate indicating standard costs of a business activity; and
means for using a design pattern to encapsulate product characteristics comprising
means for defining at least one change request based on a production scenario;
means for modifying the standardized cost estimate; and
means for deriving an updated standardized cost estimate indicating updated costs of the business activity based on the at least one change request.

14. The system of claim 13, wherein the encapsulated product characteristics are formulated as rules describing the dependency between the product characteristics.

15. The system of claim 13, wherein a manual change of the standard cost estimate does not affect the possibility for an automated processing.

16. system of claim 13, wherein the original standard cost estimate is stored in a persistent data storage device.

17. The system of claim 13, where the design pattern is a command pattern.

18. The system of claim 14, wherein the rules comprise rules for price changes and position changes.
